(19) United States
(12) Patent Application Publication
(10) Pub. No.: US 2025/0166089 A1
(43) Pub. Date: May 22, 2025

(54) ACTIVITY AREA ESTIMATION APPARATUS, ACTIVITY AREA ESTIMATION METHOD, AND NON-TRANSITORY COMPUTER READABLE MEDIUM

(71) Applicant: NEC Corporation, Tokyo (JP)

(72) Inventors: Keisuke IKEDA, Tokyo (JP); Masahiro Tani, Tokyo (JP); Kazufumi Kojima, Tokyo (JP)

(73) Assignee: NEC Corporation, Tokyo (JP)

(21) Appl. No.: 18/940,968

(22) Filed: Nov. 8, 2024

(30) Foreign Application Priority Data
Nov. 20, 2023 (JP) 2023-196789

(51) Int. Cl. G06Q 50/00

(52) U.S. Cl. CPC G06Q 50/01

(57) ABSTRACT

In order to improve accuracy of estimating an activity area of a target user, an activity area estimation apparatus includes: a first generation unit that generates, based on first posted information of a target user, first location information; a usefulness decision unit that decides, by using related user information relating to a related user being a user related to the target user, whether the first location information is useful in order to estimate an activity area of the target user in a real space; and an activity area estimation unit that estimates, by using the first location information decided as being useful, the activity area of the target user.

### TECHNICAL FIELD

This application is based upon and claims the benefit of priority from Japanese patent application No. 2023-196789, filed on Nov. 20, 2003, the disclosure of which is incorporated herein in its entirety by reference.

The present invention relates to an activity area estimation apparatus, an activity area estimation method, and a non-transitory computer readable medium.

### BACKGROUND ART

Various types of social networking services (SNSs) are being used generally and widely, and information (SNS information) provided in an SNS is used. A usage purpose of such information includes, for example, marketing, a human resource survey of a job seeker and an advanced education candidate, and the like.

Patent Document 1 (Japanese Patent Application Publication No. 2022-114389) discloses, for example, a technique for estimating, by using account information of a target user, an activity position of the target user. An estimation apparatus described in Patent Document 1 includes a first position distribution generation unit, a second position distribution generation unit, and an estimation unit.

The first position distribution generation unit generates, based on account information of a target user in social media, a first position distribution of the target user. The second position distribution generation unit generates, based on account information of a friend related to the target user in social media, a second position distribution of the friend. The estimation unit estimates, based on the generated first position distribution and the generated second position distribution, an activity position of the target user.

According to Patent Document 1, the first position distribution is generated, for example, based on posted information included in the account information.

### SUMMARY

However, generally, there are various types of position information included in posted information. The posted information may include, for example, a location which a posted person wants to visit, a related location of general news in which a posted person is interested, and the like. In this manner, in a case where posted information includes position information not relating to an activity area of a target user, the activity area of the target user is estimated by using the position information, and thereby the estimation result may be an area inappropriate as the activity area of the target user.

In view of the above-described problem, one example of an object of the present invention is to provide an activity area estimation apparatus, an activity area estimation method, a program, and the like that are capable of improving accuracy of estimating an activity area of a target user.

According to one aspect of the present invention,
provided is an activity area estimation apparatus including:
a first generation unit that generates, based on first posted information of a target user, first location information;
a usefulness decision unit that decides, by using related user information relating to a related user being a user related to the target user, whether the first location information is useful in order to estimate an activity area of the target user in a real space; and
an activity area estimation unit that estimates, by using the first location information decided as being useful, the activity area of the target user.

According to one aspect of the present invention,
provided is an activity area estimation method including,
by one or more computers:
generating, based on first posted information of a target user, first location information;
deciding, by using related user information relating to a related user being a user related to the target user, whether the first location information is useful in order to estimate an activity area of the target user in a real space; and
estimating, by using the first location information decided as being useful, the activity area of the target user.

According to one aspect of the present invention,
provided is a program for causing one or more computers to execute:
generating, based on first posted information of a target user, first location information;
deciding, by using related user information relating to a related user being a user related to the target user, whether the first location information is useful in order to estimate an activity area of the target user in a real space; and
estimating, by using the first location information decided as being useful, the activity area of the target user.

An example advantage according to the invention is to improve accuracy of estimating an activity area of a target user.

### BRIEF DESCRIPTION OF THE DRAWINGS

FIG. 1 is a diagram illustrating an outline of an activity area estimation apparatus.

FIG. 2 is a flowchart illustrating an outline of activity area estimation processing.

FIG. 3 is a diagram illustrating a configuration example of an information processing system.

FIG. 4 is a diagram illustrating a functional configuration example of the activity area estimation apparatus.

FIG. 5 is a diagram illustrating a functional configuration example of a first generation unit.

FIG. 6 is a diagram illustrating a functional configuration example of a second generation unit.

FIG. 7 is a diagram illustrating a physical configuration example of the activity area estimation apparatus.

FIG. 8 is a flowchart illustrating an example of the activity area estimation processing.

FIG. 9 is a flowchart illustrating an example of the activity area estimation processing.

FIG. 10 is a diagram illustrating one example of a posting distribution determined based on kernel density estimation.

FIG. 11 is a diagram illustrating a functional configuration example of an activity area estimation unit.

FIG. 12 is a flowchart illustrating an example of estimation processing.

FIG. 13 is a diagram illustrating one example of an activity area of a target user estimated based on a posting distribution and a related user distribution.

### EXAMPLE EMBODIMENT

Example embodiments of the present invention are described below by using drawings. Note that, in every drawing, a similar component is given a similar sign, and description thereof is omitted as appropriate.

### [Outline]

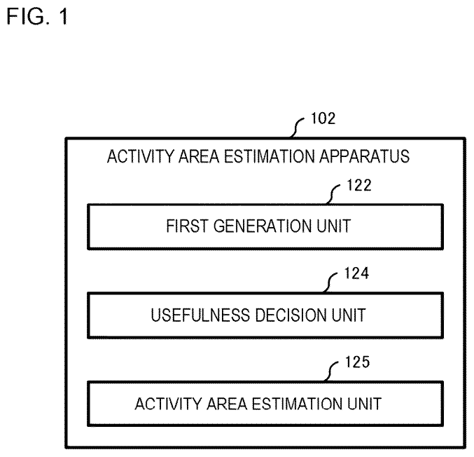

FIG. 1 is a diagram illustrating an outline of an activity area estimation apparatus 102. The activity area estimation apparatus 102 includes a first generation unit 122, a usefulness decision unit 124, and an activity area estimation unit 125.

The first generation unit 122 generates, based on first posted information of a target user, first location information.

The usefulness decision unit 124 decides, by using related user information relating to a related user being a user related to the target user, whether the first location information is useful in order to estimate an activity area of the target user in a real space.

The activity area estimation unit 125 estimates, by using the first location information decided as being useful, the activity area of the target user.

According to the activity area estimation apparatus 102, accuracy of estimating an activity area of a target user can be improved.

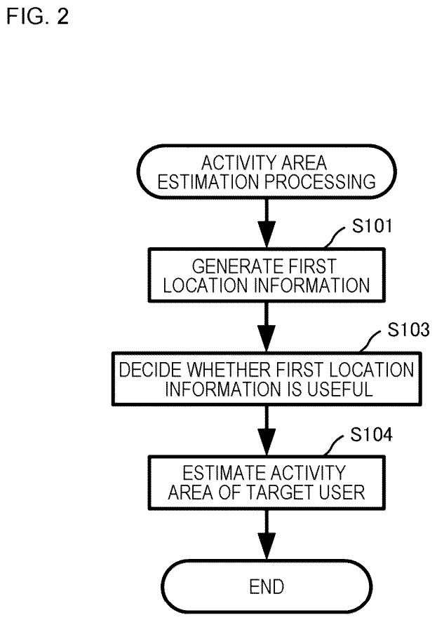

FIG. 2 is a flowchart illustrating an outline of activity area estimation processing.

The first generation unit 122 generates, based on first posted information of a target user, first location information (step S101).

The usefulness decision unit 124 decides, by using related user information relating to a related user being a user related to the target user, whether the first location information is useful in order to estimate an activity area of the target user in a real space (step S103).

The activity area estimation unit 125 estimates, by using the first location information decided as being useful, the activity area of the target user (step S104).

According to the activity area estimation apparatus 102, accuracy of estimating an activity area of a target user can be improved.

Hereinafter, details of the example embodiments are described.

### Example Embodiment 1

### (Configuration Example of Information Processing System 100)

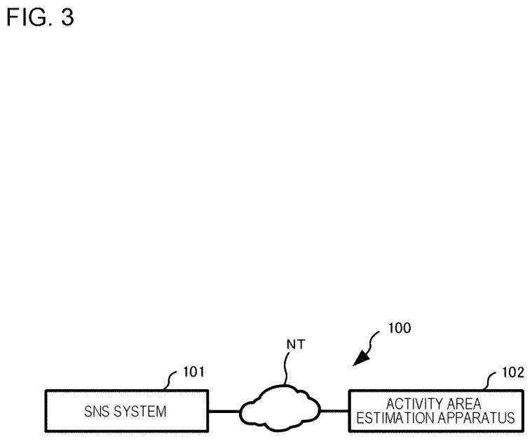

FIG. 3 is a diagram illustrating a configuration example of an information processing system 100. The information processing system 100 is a system for estimating, by using social networking service (SNS) information, an activity area of a target user in a real space. The information processing system 100 includes an SNS system 101 and an activity area estimation apparatus 102.

Hereinafter, an “activity area estimation apparatus” is also referred to simply as an “estimation apparatus”.

The SNS system 101 and the estimation apparatus 102 are connected in such a way as to be capable of mutually transmitting/receiving information via a network NT. The network NT is, for example, a communication line configured in a wired manner, a wireless manner, or based on a combination of these manners.

### (Configuration Example of SNS System 101)

The SNS system 101 is a system that provides an SNS, and includes, for example, one or a plurality of management apparatuses (not illustrated) and one or a plurality of terminal apparatuses (not illustrated). Note that, the information processing system 100 may include a plurality of SNS systems 101. In this case, each SNS system 101 may be configured similarly.

Each of one or a plurality of management apparatuses is an apparatus that manages SNS information. Each of a plurality of terminal apparatuses is an apparatus used by a user of an SNS (hereinafter, referred to also as an “SNS user”), and is, for example, a smartphone, a tablet terminal, a personal computer, or the like. Each of a plurality of terminal apparatuses is connected to one or a plurality of management apparatuses via the network NT or the like.

The SNS is a service provided by using a management apparatus. The SNS is provided, for example, for an SNS user previously registered. The SNS includes, for example, one or more of a service in which an SNS user discloses posted information by using an account of the user, a service in which contact is taken with another SNS user, and the like. Note that, the SNS is not limited thereto.

### (SNS Information)

SNS information is information used in order to provide an SNS. The SNS information includes, with respect to each SNS user, for example, at least one of (1) profile information, (2) posted information, (3) dialog information with another SNS user, and (4) associated information with another SNS user. Note that, the SNS information is not limited thereto.
(1) Profile information may include, for example, at least one of residence location information, work location information, a hobby, attribute information, or the like. Note that, the profile information is not limited thereto.

The residence location information is information indicating a residence location of an SNS user. The work location information is information indicating a work location of an SNS user. For example, each of residence location information and work location information may be indicated by a latitude and a longitude, may be indicated by an administrative district according to any of a prefecture, a municipality, a block, an address, and the like, or may be indicated by information identifying each of a plurality of previously-determined areas. The plurality of previously-determined areas are, but not limited to, for example, areas divided by a mesh of a predetermined size.

Note that, a method of indicating a position in each of residence location information and work location information is not limited to the method exemplified herein. Further, methods of indicating positions in residence location information and work location information may be the same, or may be different.

The attribute information may include, for example, one or more of gender, a birth date, and the like.
(2) Posted information may include at least one of text information, image information, or position information. The posted information may further include one or more of reaction to the posted information, posted timing, and the like. Note that, the posted information is not limited thereto.

The image information may be either or both of a still image and a moving image.

The position information is information indicating a position where posted information is uploaded onto a management apparatus. The position information may be a GEO tag such as global positioning system (GPS) information acquired by using a function of a terminal apparatus onto which posted information is uploaded. The position information may include, for example, a position determined by a management apparatus from an image of a landmark or the like included in image information.

The position information may be indicated, for example, by a latitude and a longitude, may be indicated by an administrative district according to any of a prefecture, a municipality, a block, an address, and the like, or may be indicated by information identifying each of a plurality of previously-determined areas. Note that, a method of indicating a position in the position information is not limited to the method exemplified herein.

The reaction to posted information includes, for example, a comment, “like”, and the like with respect to posted information from another SNS user. Note that, the reaction to posted information is not limited thereto.

The posted timing is information indicating timing at which posted information is uploaded onto a management apparatus. The posted timing may be represented, for example, by a date and a time. Note that, a method of representing the posted timing is not limited thereto.
(3) Dialog information includes, for example, a dialog with one SNS user or a plurality of other SNS users such as a chat
(4) Associated information includes, for example, an account of another SNS user with a predetermined relation such as a friendship and a family relationship. The friendship is, for example, a relation formed with an agreement between persons concerned. Note that, an account of another SNS user with a family relation may be included in profile information.

### (Functional Configuration Example of Activity Area Estimation Apparatus 102)

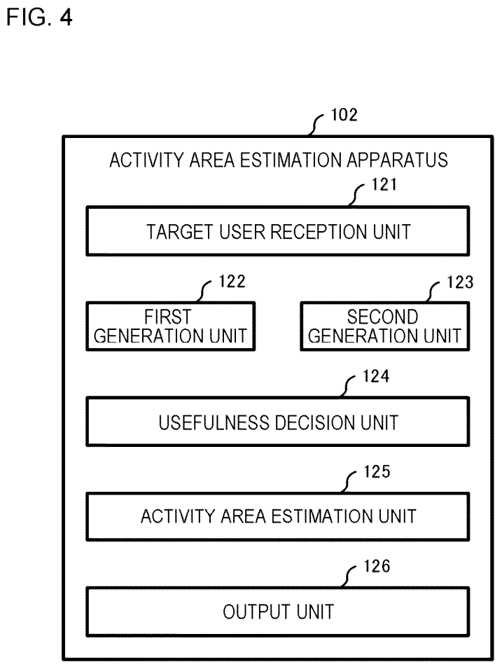

FIG. 4 is a diagram illustrating a functional configuration example of the activity area estimation apparatus 102. The estimation apparatus 102 is an apparatus that estimates, by using SNS information managed by the SNS system 101, an activity area of a target person in a real space.

The estimation apparatus 102 functionally includes, for example, a target user reception unit 121, a first generation unit 122, a second generation unit 123, a usefulness decision unit 124, an activity area estimation unit 125, and an output unit 126.

The target user reception unit 121 receives an account of a target user, for example, based on input of a user (hereinafter, referred to also as an “apparatus user”) of the estimation apparatus 102.

The target user is, for example, an SNS user selected, by an apparatus user or the like, as a target for whom an activity area is estimated.

A target account is an account used by a target user in an SNS provided by the SNS system 101. Therefore, the target account is associated with a target user, and the target user can be determined by using the target account.

The first generation unit 122 generates first location information, based on first posted information of a target user.

The first posted information is posted information included in SNS information of the target user.

The first location information is information indicating a location acquired based on the first posted information.

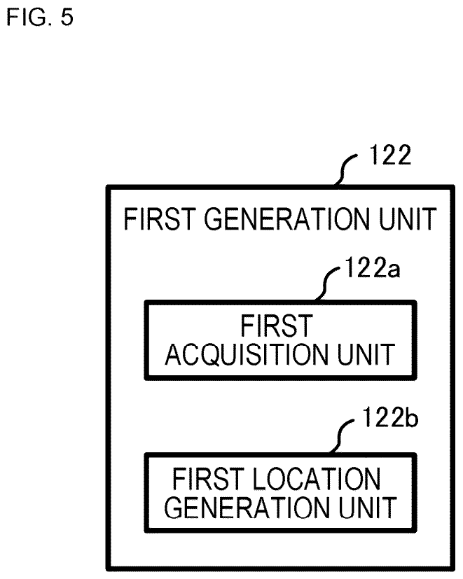

FIG. 5 is a diagram illustrating a functional configuration example of the first generation unit 122. The first generation unit 122 functionally includes, for example, a first acquisition unit 122a and a first location generation unit 122b.

The first acquisition unit 122a acquires, from the SNS system 101, at least first posted information from among pieces of SNS information of a target user.

The first location generation unit 122b generates first location information, based on the first posted information acquired by the first acquisition unit 122a. The first location information is generated, for example, by using at least one of text information, position information, and an image included in the first posted information.

Refer to FIG. 4 again.

The second generation unit 123 determines a related user of a target user, and generates, by using profile information of the related user, related user information including second location information.

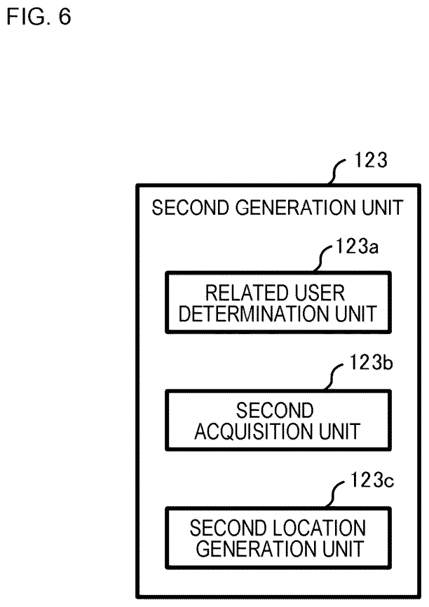

FIG. 6 is a diagram illustrating a functional configuration example of the second generation unit 123. The second generation unit 123 functionally includes, for example, a related user determination unit 123a, a second acquisition unit 123b, and a second location generation unit 123c.

The related user determination unit 123a determines a related user of a target user.

A related user is an SNS user related to a target user, and may include, for example, at least one of a directly-related user or an indirectly-related user. The directly-related user is an SNS user directly associated with a target user. The indirectly-related user is an SNS user indirectly associated with a target user. The indirectly-related user may include, for example, an SNS user associated with a directly-related user. The indirectly-related user may include, for example, an SNS user associated with an indirectly-related user.

There are various types of methods for determining, by the related user determination unit 123a, a related user. A method of determining a related user is described later. The second acquisition unit 123b acquires at least profile information from among pieces of SNS information of a related user determined by the related user determination unit 123a.

The second location generation unit 123c acquires residence location information from profile information of a related user acquired by the second acquisition unit 123b, and generates related user information including second location information. The second location information may include, for example, the acquired residence location information. Note that, the second location information may be information indicating an activity location of a related user, may be residence location information of a related user as described above, or may include another piece of information. As another piece of information, for example, work location information of a related user can be cited.

Refer to FIG. 4 again.

The usefulness decision unit 124 decides, by using related user information relating to a related user, whether first location information is useful in order to estimate an activity area of a target user in a real space.

The usefulness decision unit 124 may decide, for example, by using related user information and a previously-determined decision criterion, whether first location information in useful. Then, the usefulness decision unit 124 may decide, for example, in a case where the decision criterion is satisfied, that the first location information is useful. Further, the usefulness decision unit 124 may decide, for example, in a case where the decision criterion is not satisfied, that the first location information is not useful.

Details of the decision criterion are described later.

The activity area estimation unit 125 estimates, by using first location information decided as being useful by the usefulness decision unit 124, an activity area of a target user. For the estimation, a general method is usable. An example of the method is described later.

The output unit 126 outputs activity area information including an activity area estimated by the usefulness decision unit 124.

So far, a functional configuration example of the estimation apparatus 102 has been described. Note that, the estimation apparatus 102 may include, for example, a function of either or both of a management apparatus and a terminal apparatus included in the SNS system 101. Hereinafter, a physical configuration example of the estimation apparatus 101 is described.

### (Physical Configuration Example of Activity Area Estimation Apparatus 102)

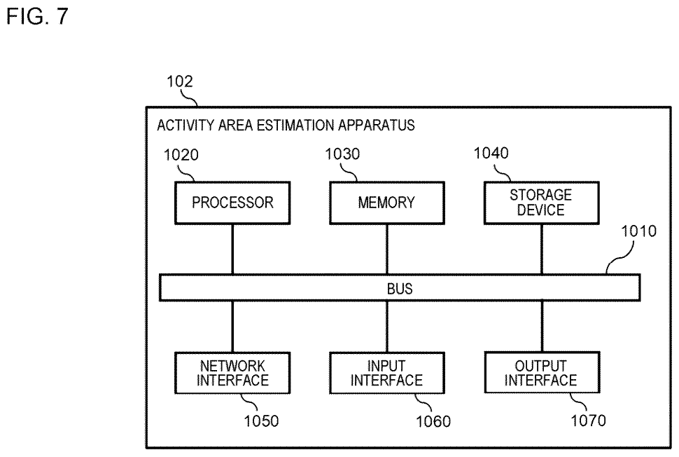

FIG. 7 is a diagram illustrating a physical configuration example of the activity area estimation apparatus 102. The estimation apparatus 102 physically includes, for example, a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module achieving a function of an apparatus including the storage device 1040. The processor 1020 reads each of the program modules onto the memory 1030 and executes the read program module, and thereby achieves each function relevant to the program module.

The network interface 1050 is an interface for connecting an apparatus including the network interface 1050 to the network NT.

The input interface 1060 is an interface for inputting information by a user. The input interface 1060 is configured, for example, by a touch panel, a keyboard, a mouse, or the like.

The output interface 1070 is an interface for providing information for a user. The output interface 1070 is configured, for example, by a liquid crystal panel, an organic electro-luminescence (EL) panel, or the like.

Note that, the estimation apparatus 102 may be physically configured by a plurality of apparatuses. Each apparatus in this case may include, for example, the configuration illustrated in FIG. 7. Further, each apparatus such as a management apparatus and a terminal apparatus configuring the SNS system 101 may include, for example, the configuration illustrated in FIG. 7.

### (Operation Example of Activity Area Estimation Apparatus 102)

The activity area estimation apparatus 102 executes activity area estimation processing.

The activity area estimation processing is processing of estimating, by using SNS information, an activity area of a target person in a real space. The activity area estimation processing is started at a time when, for example, the target user reception unit 121 receives an account of a target user. Note that, a trigger for starting the activity area estimation processing is not limited thereto.

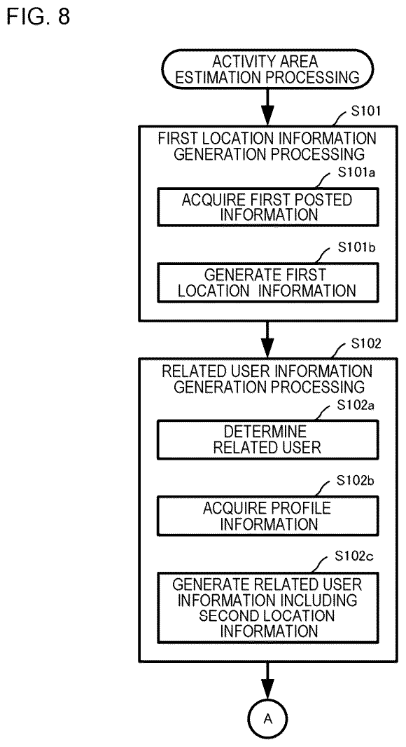

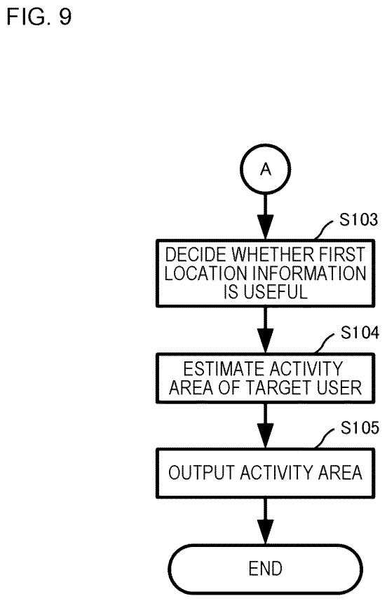

FIGS. 8 and 9 are a flowchart illustrating an example of the activity area estimation processing.

Refer to FIG. 8.

The first generation unit 122 generates, based on first posted information of a target user, first location information (step S101).

For details, for example, the first acquisition unit 122a acquires, from the SNS system 101 at least first posted information from among pieces of SNS information (i.e., SNS information of a target user) of an account received by the target user reception unit 121 (step S101a).

The target user reception unit 121 may receive a specified period, together with an account of a target user. In this case, the first acquisition unit 122a may acquire, from the SNS system 101, at least first posted information from among pieces of SNS information of the target user in which posted timing is included in the specified period.

The first location generation unit 122b generates first location information, based on the first posted information acquired in step S101a (step S101b). One piece or a plurality of pieces of first location information are applicable.

As descried above, the first location information is generated, for example, by using at least one of text information, position information, and an image.

In a case where text information included in the first posted information is used, the first location generation unit 122b may extract, for example, a location included in the text information, and generate the first location information including the extracted location.

A location included in text information is, but not limited to, for example, a geographical name, an address, a facility name, and the like. For details, for example, from text information being “A festival may be held at ∘∘ Station in a vicinity”, the first location information including “∘∘ Station” is generated. For example, from text information being “It seems to be cold in Tokyo but it seems to be worm in a local area”, the first location information including “Tokyo” is generated. For example, from text information being “I wish to go to New York someday”, the first location information including “New York” is generated.

In a case where position information included in the first posted information is used, the first location generation unit 122b may generate the first location information including the position information.

In a case where an image included in the first posted information is used, the first location generation unit 122b may generate, for example, in a case where a predetermined image such as a landmark is extracted from the image, the first location information including a location relevant to the predetermined image. The predetermined image may be previously stored, for example, in the first location generation unit 122b. Further, as a technique for extracting a predetermined image, a general technique such as pattern matching and a machine learning model is usable.

The second generation unit 123 determines a related user of the target user, and generates, by using profile information of the related user, related user information including second location information (step S102).

For details, for example, the related user determination unit 123a determines a related user of the target user (step S102a).

### (Method of Determining Related User)

The related user determination unit 123a may determine a related user, by using at least one piece of information, for example, such as association information, dialog information, and posted information (first posted information) with the target user. The related user determination unit 123a may appropriately acquire the at least one piece of information used in order to determine a related user, from either or both of the SNS system 101 and the first acquisition unit 122a.

In a case where association information is used, for example, the related user determination unit 123a may determine, as a related user, an SNS user who uses an account included in the association information.

In a case where dialog information is used, for example, the related user determination unit 123a may determine, as a related user, an SNS user who uses an account of a partner of a dialog in the dialog information.

In a case where first posted information is used, for example, the related user determination unit 123a may determine, as a related user, an SNS user relevant to a name, an account, or the like included in the first posted information. Further, for example, the related user determination unit 123a may determine, as a related user an SNS user captured together with the target user in a photograph included in the first posted information.

One or a plurality of related users determined in step S102a are applicable.

The second acquisition unit 123b acquires at least profile information from among pieces of SNS information of the related user determined in step S102a (step S102b).

In a case where a plurality of related users are determined in step S102a, the second acquisition unit 123b may acquire at least profile information for each of the plurality of related users.

The second location generation unit 123c generates, by using the profile information acquired in step S102b, related user information including second location information (step S102c).

For example, as described above, the second location generation unit 123c acquires residence location information from the profile information acquired in step S102b. Then, the second location generation unit 123c generates second location information including the acquired residence location information. Further, the second location generation unit 123c may generate, as necessary, related user information further including another piece of information, in addition to the second location information.

In a case where a plurality of related users are determined in step S102a, the second location generation unit 123c may generate related user information including second location information for each of the plurality of related users. For details, for example, the second location generation unit 123c may generate a plurality of pieces of second location information including residence location information of each of a plurality of related users. Then, the second location generation unit 123c may generate a plurality of pieces of related user information including each of the plurality of pieces of generated second location information.

Refer to FIG. 9.

The usefulness decision unit 124 decides, by using the related user information generated in step S102c, whether the first location information is useful in order to estimate an activity area of the target user in a real space (step S103).

### (Decision Criterion)

A decision criterion includes a criterion 1 described below. Further, the decision criterion may further include at least one of a criterion 2 to a criterion 4 described below. Note that, the decision criterion is not limited thereto.

(Criterion 1) A criterion relating to a position relation in a real space between locations indicated by first location information and second location information each

For details, for example, the criterion 1 indicates that a location indicated by the first location information is included in a location indicated by the second location information in a real space.

For more details, for example, it is assumed that there are a plurality of pieces of first location information being “∘∘ Station”, “Tokyo”, and “New York” described above. Further, it is assumed that there are a plurality of related users and pieces of residence location information included in pieces of second location information of the plurality of related users each are “Kyoto City”, “Osaka City”, and “Kobe City”. In a case where, for example, “∘∘ Station” is included in “Osaka City”, the usefulness decision unit 124 decides that “∘∘ Station” is useful.

Note that, the criterion 1 is not limited thereto. For example, a location indicated by the first location information and a location indicated by the second location information may be overlapped with each other in a real space. The criterion 1 may indicate that a distance in a real space between locations indicated by the first location information and the second location information each is equal to or less than a previously-determined threshold value. Further, a decision criterion may include one criterion equivalent to the criterion 1, or may include a plurality of criteria equivalent to the criterion 1.

(Criterion 2) A criterion relating to a previously-determined specific location

For details, for example, the criterion 2 indicates that the first location information is not relevant to a previously-determined specific location. The specific location is, for example, a location, such as Sky Tree and Tokyo Tower, generally visited on a sightseeing trip, a location frequently cited in a general conversation topic, and the like.

Note that, the criterion 2 is not limited thereto. The criterion 2 may indicate that the first location information is relevant to, for example, a previously-determined specific location.

(Criterion 3) A criterion relating to a position relation in a real space of a location included, in a case where there are a plurality of pieces of first location information, in the plurality of pieces of first location information.

For details, for example, the criterion 3 indicates that a distance in a real space of a location included in a plurality of pieces of first location information is equal to or less than a previously-determined threshold value. The threshold value may be the same as or different from a threshold value used in another criterion.

For more details, for example, it is assumed that a plurality of pieces of first location information are “Tokyo”, “Shinjuku”, “Shibuya”, and “Osaka City”. Further, it is assumed that the threshold value is 100 km. “Osaka City” is more than 100 km away from each of “Tokyo”, “Shinjuku”, and “Shibuya”. Further, each location of “Tokyo”, “Shinjuku”, and “Shibuya” is equal to or less than 100 km away from at least one of the other locations.

In this case, the usefulness decision unit 124 decides that “Osaka City” is not useful. Further, the usefulness decision unit 124 decides that “Tokyo”, “Shinjuku”, and “Shibuya” are useful.

Note that, the criterion 3 is not limited thereto.

(Criterion 4) A criterion relating to a hobby or an attribute of a related user

For details, for example, the criterion 4 indicates that a location indicated by the first location information is a location relating to a hobby or an attribute of a related user.

For more details, for example, it is assumed that a hobby of a related user is “movie watching” and a location indicated by the first location information is a filming location of a movie. In this case, the usefulness decision unit 124 decides that the first location information is useful.

In a case where a decision criterion includes a plurality of criteria, an application relation (priority order to be applied or the like) among the plurality of criteria may be appropriately determined.

The usefulness decision unit 124 may decide, in a case where, in step S102c, a plurality of pieces of related user information including a plurality of pieces of second location information each are generated, whether the first location information is useful, by using the plurality of pieces of second location information. In other words, in this case, whether the first location information is useful may be decided by using the plurality of pieces of second location information included in the plurality of pieces of related user information each.

The activity area estimation unit 125 estimates, by using the first location information decided as being useful in step S103, an activity area of the target user (step S104).

The activity area estimation unit 125 generates, as an activity area of the target user, for example, a distribution (posting distribution) in a real space of a location indicated by the first location information decided as being useful in step S103.

The posting distribution can be referred to as a distribution in a real space of a location useful in order to estimate an activity area of the target user among locations (i.e., pieces of first location information) acquired based on the first posted information. There may be various types of methods of representing a posting distribution. The posting distribution may be, for example, a two-dimensional geographical distribution represented, for example, by using coordinates of a latitude and a longitude. The posting distribution may be a two-dimensional geographical distribution represented, for example, by using a unit area of a predetermined size. The unit area may be an area according to an administrative district such as a nation unit, a prefecture unit, a city or ward unit, a town or village unit, and the like, or may be an area divided by a mesh of a predetermined size such as 1 km×1 km, 100 m×100 m, and the like. Note that, a method of representing a posting distribution is not limited thereto.

The activity area estimation unit 125 may estimate, as described above, a posting distribution, for example, by using a general method. Then, the activity area estimation unit 125 may use the estimated posting distribution as an activity area estimated for the target user (i.e., an activity area of the target user). For details, for example, as disclosed in Japanese Patent Application Publication No. 2022-114389, a posting distribution may be generated by using a previously-determined distribution function. As one example of the distribution function, a density estimation function for estimating, based on a non-parametric method, a distribution may be cited. Further, as an example of the density estimation function based on a non-parametric method, a kernel density estimation function (see equation (1)) can be cited.

In generation of a posting distribution, based on the first posted information, pieces of first location information each decided as being useful may be weighted. For example, according to a posting date and time, the first location information decided as being useful may be weighted.

$$[ Mathematical 1 ]$$

$$POSTING DISTRIBUTION p ( {L}_{p} ) = \frac{1}{\vert p \vert {h}_{p}} {\sum }_{1}^{p} {w}_{p} {K}_{p} ( {l}_{p} ) \qquad ( 1 )$$

A posting distribution p(Lₚ) represented by the equation (1) is a set of kernel density estimation values of pieces of posted information in each distribution area. In the equation (1), lₚ represents a set of locations indicated by the first location information. hₚ represents a posting band width. The posting band width hₚ is a parameter indicating an influence range of each sample in kernel density estimation. The posting band width hₚ may be a previously-set value, a value acquired based on previous learning from a plurality of posting locations, or like. wₚ represents a posting weight. Kₚ represents a posting kernel function.

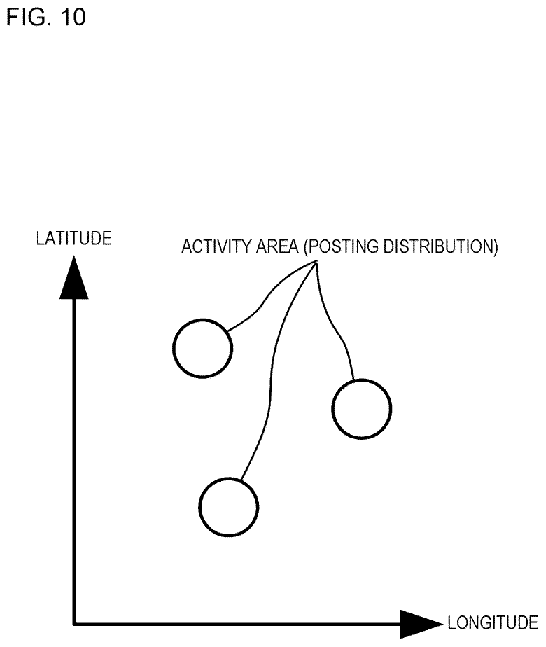

FIG. 10 is a diagram illustrating one example of a posting distribution determined based on kernel density estimation. Each of posting distributions indicates an influence range (e.g., a circle with a normal distribution) of a posting band width around a location indicated by the first location information. In an influence range of a location indicated by the first location information, a score in the center is maximum and a score decreases with increased distance from the center.

Note that, a method of generating a posting distribution is not limited thereto. A posting distribution may be generated, for example, by using appropriate statistical processing. Further, the activity area estimation unit 125 may, for example, count the number of posting locations included in each distribution area, and thereby, generate a posting distribution (histogram).

Refer to FIG. 9.

The activity area estimation unit 125 outputs the activity area estimated in step S104 (step S105), and terminates the activity area estimation processing.

There is one or a plurality of output method, for example, such as display in a display unit being not illustrated, and transmission to another apparatus being not illustrated through the network NT. Note that, the output method is not limited thereto.

### Advantageous Effect

As described above, according to the present example embodiment, the estimation apparatus 102 includes the first generation unit 122, the usefulness decision unit 124, and the activity area estimation unit 125.

The first generation unit 122 generates, based on first posted information of a target user, first location information. The usefulness decision unit 124 decides, by using related user information relating to a related user being a user related to the target user, whether the first location information is useful in order to estimate an activity area of the target user in a real space. The activity area estimation unit 125 estimates, by using the first location information decided as being useful, the activity area of the target user.

Thereby, by using related user information, from among pieces of first location information generated based on the first posted information, first location information in which a predetermined criterion is satisfied with respect to a related user (i.e., a predetermined relation is achieved) can be decided. The related user is a user related to the target user, and therefore generally, the first location information in a predetermined relation with the related user is highly likely to be an activity area of the target user. Therefore, accuracy of estimating an activity area of a target user can be improved.

According to the present example embodiment, first location information is generated by using at least one of text informant, position information, and an image included in first posted information.

In a general SNS, posted information frequently includes at least one of text informant, position information, and an image. Therefore, by using posted information of a general SNS, first location information can be generated. Therefore, accuracy of estimating an activity area of a target user using a general SNS can be improved.

According to the present example embodiment, the estimation apparatus 102 includes the second generation unit 123 that determines a related user of a target user, and generates, by using profile information of the related user, related user information including second location information.

In a general SNS, profile information frequently includes a location where a user of the SNS is present on a daily basis such as a residence location and a work location. Therefore, by using a location where a related user is present on a daily basis, it can be decided whether first location information is useful, and therefore it is highly likely that usefulness of the first location information can be appropriately decided. Therefore, accuracy of estimating an activity area of a target user can be improved.

According to the present example embodiment, profile information includes residence location information of a related user. Second location information includes residence location information acquired from the profile information.

Thereby, by using a location where a related user is present on a daily basis being referred to as a residence location, it can be decided whether first location information is useful, and therefore it is highly likely that usefulness of the first location information can be appropriately decided. Therefore, accuracy of estimating an activity area of a target user can be improved.

According to the present example embodiment, a related user includes at least one of a directly-related user directly associated with a target user and an indirectly-related user associated with the directly-related user.

Thereby, by using related user information of a related user with high possibility of being relatively close to the target user, it can be decided whether first location information is useful in order to estimate an activity area of the target user in a real space. Then, by using first location information decided as being useful, an activity area can be estimated. Therefore, accuracy of estimating an activity area of the target user can be improved.

According to the present example embodiment, whether first location information is useful is decided by using related user information and a previously-determined decision criterion. The decision criterion includes a criterion relating to a position relation in a real space between locations indicted by first location information and second location information each.

By using such a decision criterion, usefulness of first location information is decided, and thereby first location information with a high possibility of relating to an activity area of a target user can be decided as being useful. Therefore, accuracy of estimating an activity area of the target user can be improved.

According to the present example embodiment, a related user is included in a plurality of related users. Related user information is included in a plurality of pieces of related user information of the plurality of related users each. Second location information is included in a plurality of pieces of second location information of the plurality of related users each. Whether first location information is useful is decided by using the plurality of pieces of second location information of the plurality of related users each.

Thereby, by using second location information relating to each of a plurality of related users, usefulness of first location information can be decided. A plurality of pieces of second location information are used, and thereby an activity area of a target user can be estimated by using a plurality of pieces of useful first location information. Therefore, accuracy of estimating an activity area of a target user can be improved.

### Example Embodiment 2

In the example embodiment 1, an example in which, by using only first location information decided as being useful, an activity area of a target user is estimated has been described. In order to estimate an activity area of a target user, further, second location information may be usable.

In the present example embodiment, for concise description, a point different from the example embodiment 1 is mainly described, and description overlapping with the example embodiment 1 is omitted as appropriate.

An estimation apparatus may functionally include, for example, an activity area estimation unit 225, instead of the activity area estimation unit 125 according to the example embodiment 1.

In this case, an information processing system may be configured substantially similarly to the information processing system 100 according to the example embodiment 1, except that the estimation apparatus includes the activity area estimation unit 255, instead of the activity area estimation unit 125.

### (Functional Configuration Example of Activity Area Estimation Unit 225)

The activity area estimation unit 225 estimates an activity area of a target user, by using first location information decided as being useful by a usefulness decision unit 124 and second location information generated by a second location generation unit 123c. In other words, in the present example embodiment, an activity area of a target user is estimated by further using second location information.

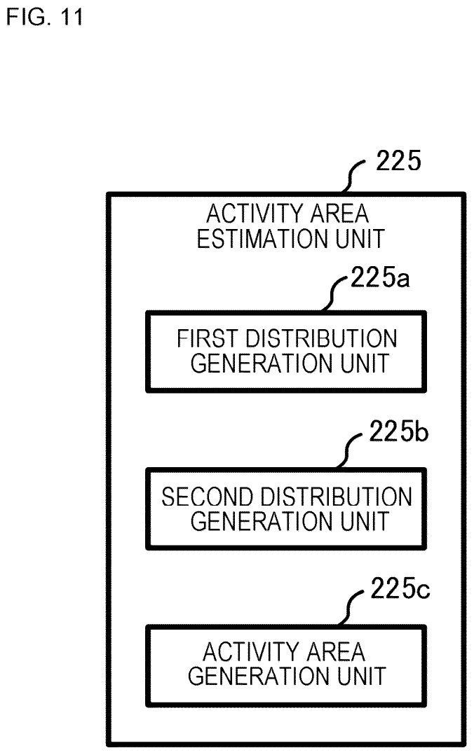

FIG. 11 is a diagram illustrating a functional configuration example of the activity area estimation unit 225. The activity area estimation unit 225 functionally includes, for example, a first distribution generation unit 225a, a second distribution generation unit 225b, and an activity area generation unit 225c.

The first distribution generation unit 225a generates a posting distribution, by using first location information decided as being useful by the usefulness decision unit 124.

The second distribution generation unit 225b generates a related user distribution, by using second location information generated by the second location generation unit 123c.

The related user distribution is a distribution in a real space of a location indicated by second location information generated by the second location generation unit 123c. The second location information is, for example, a residence location, a work location, or the like of a related user as described above, and may be information indicating an activity location of the related user. Therefore, the related user distribution can be referred to also as a distribution of activity locations of a related user.

The activity area generation unit 225c estimates, as an activity area of a target user, an area where a posting distribution and a related user distribution generated by the first distribution generation unit 225a and the second distribution generation unit 225b each are overlapped with each other. In other words, an activity area of a target user is estimated by using an overlap between a posting distribution generated based on first location information and a related user distribution generated based on second location information.

### (Another Example of Operation of Activity Area Estimation Apparatus)

Activity area estimation processing includes estimation processing (step S204), instead of estimation processing (step S104) according to the example embodiment 1. In this case, the activity area estimation processing may be configured, except this point, substantially similarly to activity area estimation processing according to the example embodiment 1.

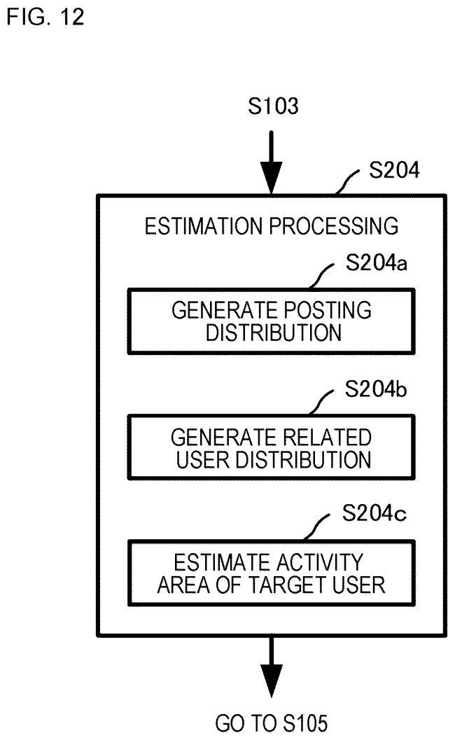

FIG. 12 is a flowchart illustrating an example of the estimation processing (step S204).

The first distribution generation unit 225a generates a posting distribution, by using first location information decided as being useful in step S103 (step S204a).

The posting distribution may be similar to a posting distribution according to the example embodiment 1. Therefore, the first distribution generation unit 225a may generate a posting distribution, by using a method similar to the method of generating a posting distribution by the activity area estimation unit 125 according to the example embodiment 1.

The second distribution generation unit 225b generates a related user distribution, by using second location information generated in step S102c (step S204b).

The second distribution generation unit 225b may generate a related user distribution, for example, by using a method substantially similar to the method of generating a posting distribution by the activity area estimation unit 125 according to the example embodiment 1. In other words, the second distribution generation unit 225b may generate a related user distribution instead of a posting distribution, by using second location information instead of first location information in the method of generating a posting distribution by the activity area estimation unit 125 according to the example embodiment 1.

The activity area generation unit 225c estimates, as an activity area of a target user, an area where a posting distribution and a related user distribution generated by the first distribution generation unit 225a and the second distribution generation unit 225b each are overlapped with each other (step S204c).

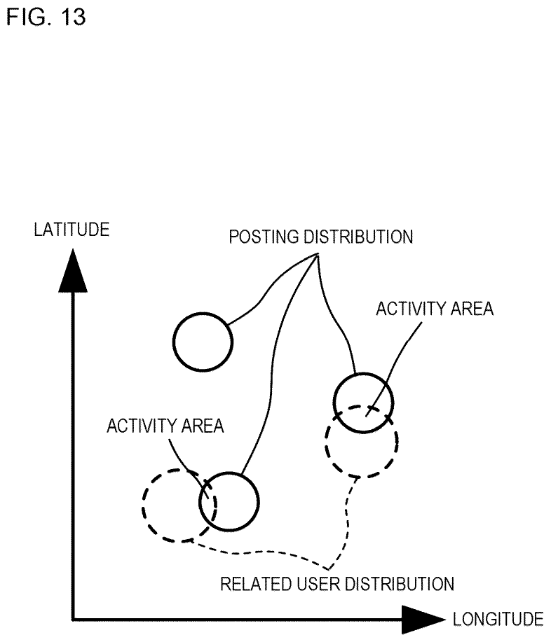

FIG. 13 is a diagram illustrating one example of an activity area of a target user estimated based on a posting distribution and a related user distribution. In the figure, the posting distribution and the related user distribution each are illustrated by a solid line and a dotted line. In the figure, the activity area of a target user is an area where the posting distribution represented by the solid line and the related user distribution represented by the dotted line are overlapped with each other.

Note that, in the figure, an example in which there are a plurality of pieces of first location information and a plurality of pieces of second location information, and based on the situation, there are a plurality of posting distributions and a plurality of related user distributions is illustrated, but there may be one or more pieces of first location information and one or more pieces of second location information. Therefore, there may be also one or more posting distributions and one or more related user distributions.

### Advantageous Effect

As described above, according to the present example embodiment, an activity area of a target user is estimated by further using second location information.

Thereby, compared with a case where an activity area is estimated only based on first location information, an activity area can be narrowed down to a more appropriate area. Therefore, accuracy of estimating an activity area of a target user can be improved.

According to the present example embodiment, an activity area of a target user is estimated by using an overlap between a posting distribution generated based on first location information and a related user distribution generated based on second location information.

Thereby, compared with a case where an activity area is estimated only based on first location information, an activity area can be narrowed down to a more appropriate area.

Therefore, accuracy of estimating an activity area of a target user can be improved.

While the example embodiments and the modified examples of the present invention have been described with reference to the drawings, the example embodiments and the modified examples are only exemplification of the present invention, and various configurations other than the above-described example embodiments and the modified examples can also be employed.

Further, in a plurality of flowcharts used in the above-described description, a plurality of steps (pieces of processing) are described in order, but execution order of steps to be executed in each example embodiment is not limited to the described order. According to each example embodiment, order of illustrated steps can be modified within an extent that there is no harm in context. Further, the above-described example embodiments and modified examples can be combined within an extent that there is no conflict in content.

The whole or part of the example embodiments disclosed above can be described as, but not limited to, the following supplementary notes.
1. An activity area estimation apparatus including:
   a first generation unit that generates, based on first posted information of a target user, first location information;
   a usefulness decision unit that decides, by using related user information relating to a related user being a user related to the target user, whether the first location information is useful in order to estimate an activity area of the target user in a real space; and
   an activity area estimation unit that estimates, by using the first location information decided as being useful, the activity area of the target user.
2. The activity area estimation apparatus according to supplementary note 1, wherein
   the first location information is generated by using at least one of text information, position information, and an image included in the first posted information.
3. The activity area estimation apparatus according to supplementary note 1 or 2, further including
   a second generation unit that determines the related user of the target user, and generates, by using profile information of the related user, the related user information including second location information.
4. The activity area estimation apparatus according to supplementary note 3, wherein
   the profile information includes residence location information of the related user, and
   the second location information includes the residence location information acquired from the profile information.
   5. The activity area estimation apparatus according to supplementary note 3 or 4, wherein the related user includes at least one of a directly-related user directly associated with the target user and an indirectly-related user associated with the directly-related user.
6. The activity area estimation apparatus according to any one of supplementary notes 3 to 5, wherein
   whether the first location information is useful is decided by using the related user information and a previously-determined decision criterion, and
   the decision criterion includes a criterion relating to a position relation in a real space between location indicated by the first location information and the second location information each.
7. The activity area estimation apparatus according to any one of supplementary notes 3 to 6, wherein
   the related user is included in a plurality of related users,
   the related user information is included in a plurality of pieces of related user information of the plurality of related users each,
   the second location information is included in a plurality of pieces of second location information of the plurality of related users each, and
   whether the first location information is useful is decided by using a plurality of pieces of second location information included in the plurality of pieces of related user information each.
8. The activity area estimation apparatus according to any one of supplementary notes 3 to 6, wherein
   the activity area of the target user is estimated by further using the second location information.
9. The activity area estimation apparatus according to supplementary note 8, wherein
   the activity area of the target user is estimated by using an overlap between a posting distribution generated based on the first location information and a related user distribution generated based on the second location information.
10. An activity area estimation method including,
   by one or more computers:
   generating, based on first posted information of a target user, first location information;
   deciding, by using related user information relating to a related user being a user related to the target user, whether the first location information is useful in order to estimate an activity area of the target user in a real space; and
   estimating, by using the first location information decided as being useful, the activity area of the target user.
11. The activity area estimation method according to supplementary note 10, wherein
   the first location information is generated by using at least one of text information, position information, and an image included in the first posted information.
12. The activity area estimation method according to supplementary note 10 or 11, further including
   determining the related user of the target user, and generating, by using profile information of the related user, the related user information including second location information.
13. The activity area estimation method according to supplementary note 12, wherein
   the profile information includes residence location information of the related user, and
   the second location information includes the residence location information acquired from the profile information.
14. The activity area estimation method according to supplementary note 12 or 13, wherein
   the related user includes at least one of a directly-related user directly associated with the target user and an indirectly-related user associated with the directly-related user.
15. The activity area estimation method according to any one of supplementary notes 12 to 14, wherein
   whether the first location information is useful is decided by using the related user information and a previously-determined decision criterion, and
   the decision criterion includes a criterion relating to a position relation in a real space between locations indicated by the first location information and the second location information each.
16. The activity area estimation method according to any one of supplementary notes 12 to 15, wherein
   the related user is included in a plurality of related users,
   the related user information is included in a plurality of pieces of related user information of the plurality of related users each,
   the second location information is included in a plurality of pieces of second location information of the plurality of related users each, and
   whether the first location information is useful is decided by using a plurality of pieces of second location information included in the plurality of pieces of related user information each.
17. The activity area estimation method according to any one of supplementary notes 12 to 15, wherein
   the activity area of the target user is estimated by further using the second location information.
18. The activity area estimation method according to supplementary note 17, wherein
   the activity area of the target user is estimated by using an overlap between a posting distribution generated based on the first location information and a related user distribution generated based on the second location information.
19. A program for causing one or more computers to execute:
   generating, based on first posted information of a target user, first location information;
   deciding, by using related user information relating to a related user being a user related to the target user, whether the first location information is useful in order to estimate an activity area of the target user in a real space; and
   estimating, by using the first location information decided as being useful, the activity area of the target user.
20. The program according to supplementary note 19, wherein
   the first location information is generated by using at least one of text information, position information, and an image included in the first posted information.
21. The program according to supplementary note 19 or 20, for causing the one or more computers to further execute
   determining the related user of the target user, and generating, by using profile information of the related user, the related user information including second location information.
22. The program according to supplementary note 21, wherein
   the profile information includes residence location information of the related user, and
   the second location information includes the residence location information acquired from the profile information.
23. The program according to supplementary note 21 or 22, wherein
   the related user includes at least one of a directly-related user directly associated with the target user and an indirectly-related user associated with the directly-related user.
24. The program according to any one of supplementary notes 21 to 23, wherein
   whether the first location information is useful is decided by using the related user information and a previously-determined decision criterion, and
   the decision criterion includes a criterion relating to a position relation in a real space between locations indicated by the first location information and the second location information each.
25. The program according to any one of supplementary notes 21 to 24, wherein
   the related user is included in a plurality of related users,
   the related user information is included in a plurality of pieces of related user information of the plurality of related users each,
   the second location information is included in a plurality of pieces of second location information of the plurality of related users each, and
   whether the first location information is useful is decided by using a plurality of pieces of second location information included in the plurality of pieces of related user information each.
26. The program according to any one of supplementary notes 21 to 24, wherein
   the activity area of the target user is estimated by further using the second location information.
27. The program according to supplementary note 26, wherein
   the activity area of the target user is estimated by using an overlap between a posting distribution generated based on the first location information and a related user distribution generated based on the second location information.
28. A medium recording the program according to any one of supplementary notes 19 to 27.
100 Information processing system
101 SNS system
102 Activity area estimation apparatus
121 Target user reception unit
122 First generation unit
122a First acquisition unit
122b First location generation unit
123 Second generation unit
123a Related user determination unit
123b Second acquisition unit
123c Second location generation unit
124 Usefulness decision unit
125, 225 Activity area estimation unit
126 Output unit
225a First distribution generation unit
225b Second distribution generation unit
225c Activity area generation unit

1. An activity area estimation apparatus comprising:
a memory configured to store instructions; and
a processor configured to execute the instructions to:
generate, based on first posted information of a target user, first location information;
decide, by using related user information relating to a related user being a user related to the target user, whether the first location information is useful in order to estimate an activity area of the target user in a real space; and
estimate, by using the first location information decided as being useful, the activity area of the target user.

2. The activity area estimation apparatus according to claim 1, wherein
the first location information is generated by using at least one of text information, position information, and an image included in the first posted information.

3. The activity area estimation apparatus according to claim 1, wherein
the processor configured further to execute the instructions to
determine the related user of the target user, and generates, by using profile information of the related user, the related user information including second location information.

4. The activity area estimation apparatus according to claim 3, wherein
the profile information includes residence location information of the related user, and
the second location information includes the residence location information acquired from the profile information.

5. The activity area estimation apparatus according to claim 3, wherein
the related user includes at least one of a directly-related user directly associated with the target user and an indirectly-related user associated with the directly-related user.

6. The activity area estimation apparatus according to claim 3, wherein
whether the first location information is useful is decided by using the related user information and a previously-determined decision criterion, and
the decision criterion includes a criterion relating to a position relation in a real space between locations indicated by the first location information and the second location information each.

7. The activity area estimation apparatus according to claim 3, wherein
the related user is included in a plurality of related users,
the related user information is included in a plurality of pieces of related user information of the plurality of related users each,
the second location information is included in a plurality of pieces of second location information of the plurality of related users each, and
whether the first location information is useful is decided by using a plurality of pieces of second location information included in the plurality of pieces of related user information each.

8. The activity area estimation apparatus according to claim 3 wherein
the activity area of the target user is estimated by further using the second location information.

9. An activity area estimation method comprising,
by one or more computers:
generating, based on first posted information of a target user, first location information;
deciding, by using related user information relating to a related user being a user related to the target user, whether the first location information is useful in order to estimate an activity area of the target user in a real space; and
estimating, by using the first location information decided as being useful, the activity area of the target user.

10. A non-transitory computer readable medium storing program for causing one or more computers to execute:
generating, based on first posted information of a target user, first location information;
deciding, by using related user information relating to a related user being a user related to the target user, whether the first location information is useful in order to estimate an activity area of the target user in a real space; and
estimating, by using the first location information decided as being useful, the activity area of the target user.
